(19) United States
(12) Patent Application Publication
(10) Pub. No.: US 2011/0304420 A1
(43) Pub. Date: Dec. 15, 2011

(54) Heat-Dissipating Structure for Inductor

(76) Inventor: Jung-Fong Chang, Bade City (TW)

(21) Appl. No.: 12/815,466

(22) Filed: Jun. 15, 2010

(51) Int. Cl. H01F 27/08

(52) U.S. Cl. 336/61

(57) ABSTRACT

An inductor includes a conductive coil and a magnetic enveloping layer surrounding and bonded to the conductive coil. The magnetic enveloping layer includes a top face, a bottom face spaced from the top face in a longitudinal direction, and a plurality of side faces extending between the top and bottom faces. The conductive coil including two terminals exposed outside of the magnetic enveloping layer. At least one of the side faces includes a plurality of heat-dissipating ribs. The dissipating ribs are spaced from each other with a heat-dissipating groove formed between two adjacent heat-dissipating ribs. The heat-dissipating ribs and at least one of the side face are integrally formed as a single and inseparable component of the same material.

### BACKGROUND OF THE INVENTION

The present invention relates to heat-dissipating structure and, more particularly, to heat-dissipating structure suitable for an electronic element such as a power inductor.

In manufacture of a conventional inductor, a conductive coil receiving a magnetic core is placed into a chamber of a frame and then fixed in the chamber by a filler or injection material. Two terminals of the conductive coil are bent and located outside of the frame. Since the conductive coil is not integrally formed with the frame, the performance of the conductor is not satisfactory.

Current conductors are formed by pressing metal powders to form a magnetic enveloping layer surrounding the conductive coil through use of a powder press machine and a press die device. Specifically, a conductive coil and metal powders are placed in a cavity of a mold. The metal powders are pressed by upper and lower dies to rapidly form a magnetic enveloping layer surrounding the conductive coil.

Both of conventional inductors and the conductors formed by powder pressing generate a considerable amount of heat during use. In particular, current power conductors require high current and high power during working, aggravating the heat-dissipating problem and adversely affecting the performance and stability of the inductors.

Thus, a need exists for an inductor with heat-dissipating structure to avoid excessive heat during use.

### BRIEF SUMMARY OF THE INVENTION

An objective of the present invention is to provide an inductor including a plurality of heat-dissipating ribs on an outer face of the magnetic enveloping layer to increase the heat-dissipating area, to enhance the heat-dissipating efficiency, to increase the heat-dissipating speed, and to obtain satisfactory performance and stable operation while allowing automatic mass production of the power inductor.

The present invention fulfills the above objective by providing, in a preferred form, an inductor including a conductive coil and a magnetic enveloping layer surrounding and bonded to the conductive coil. The magnetic enveloping layer includes a top face, a bottom face spaced from the top face in a longitudinal direction, and a plurality of side faces extending between the top and bottom faces. The conductive coil including two terminals exposed outside of the magnetic enveloping layer. At least one of the side faces includes a plurality of heat-dissipating ribs.

In a preferred form, the conductive coil further includes a coil portion intermediate the two terminals. The coil portion has a plurality of turns arranged in a longitudinal direction. The heat-dissipating ribs are formed on each of two opposite side faces spaced in a direction perpendicular to the longitudinal direction. In another preferred form, the heat-dissipating ribs are formed on each side face.

In preferred forms, the top and bottom faces and the side faces form a cube. The heat-dissipating ribs extend between and interconnect the top and bottom faces. Each heat-dissipating rib of the magnetic enveloping layer is arcuate and protrudes outward. The dissipating ribs are spaced from each other with a heat-dissipating groove formed between two adjacent heat-dissipating ribs. The heat-dissipating ribs and at least one of the side faces are integrally formed as a single and inseparable component of the same material. The heat-dissipating ribs and the heat-dissipating grooves together form a wavy shape. The top face of the magnetic enveloping layer includes a bulged portion. The bulged portion includes a central section and a peripheral section surrounding the central section. The central section has a spacing to the bottom face in the longitudinal direction larger than the peripheral section.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a top, perspective view of an inductor of a first embodiment according to the preferred teachings of the present invention.

FIG. 2 shows a bottom, perspective view of the inductor of FIG. 1.

FIG. 3 shows a cross sectional view of the inductor of FIG. 1.

FIG. 4 shows a side view of the inductor of FIG. 1.

FIG. 5 shows another side view of the inductor of FIG. 1.

FIG. 6 shows a top view of the inductor of FIG. 1.

FIG. 7 shows a top, perspective view of an inductor of a second embodiment according to the preferred teachings of the present invention.

FIG. 8 shows a bottom, perspective view of the inductor of FIG. 7.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

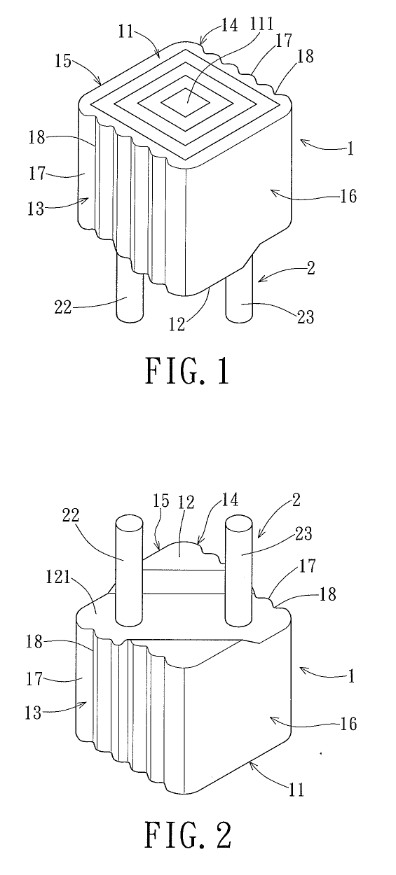

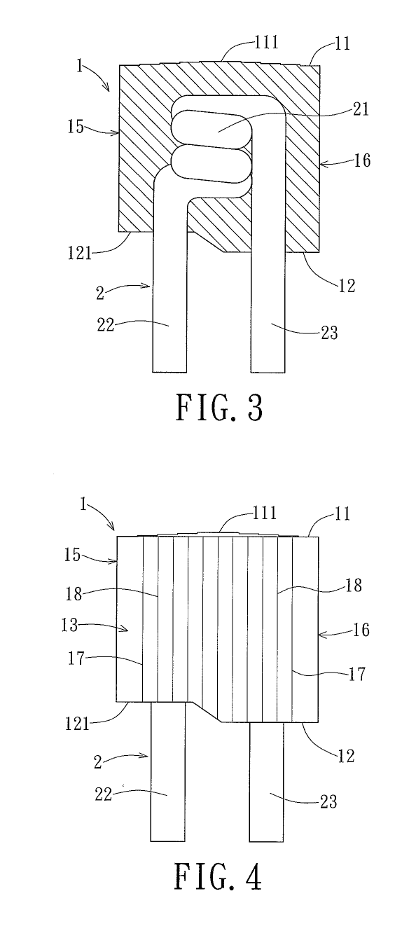

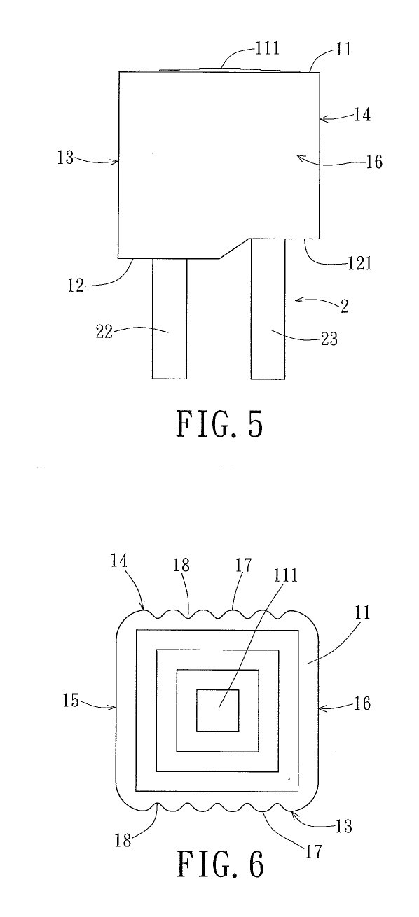

Heat-dissipating structure according to the preferred teachings of the present invention is shown in the drawings and suitable for an inductor made by pressing to integrally form the heat-dissipating structure on an outer side of the inductor. In preferred forms shown in FIGS. 1-8, the inductor includes a conductive coil 2 and a magnetic enveloping layer 1 surrounding and bonded to the conductive coil 2. The conductive coil 2 includes two terminals 22 and 23 exposed outside of the magnetic enveloping layer 1. The conductive coil 2 further includes a coil portion 21 intermediate the terminals 22 and 23. The coil portion 21 includes a plurality of turns spaced in a longitudinal direction. The magnetic enveloping layer 1 can be integrally formed as a single and inseparable component of the same material by powder pressing to envelope and contact the conductive coil 2. As an example, powders of oxides of iron, manganese, nickel, and magnesium are mixed with a bonding agent and plastic material and then integrally formed around the conductive coil 2 by powder pressing. Heat conductive material such as silicon, aluminum or other metal or non-metal heat conductive material as well as anti-oxidation material can be added.

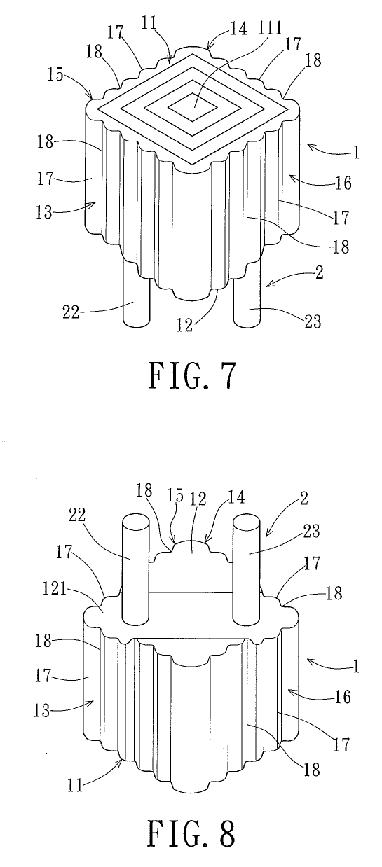

In the preferred forms shown in FIGS. 1-8, the magnetic enveloping layer 1 includes a top face 11, a bottom face 12 spaced from the top face 11 in the longitudinal direction, and a plurality of planar side faces 13, 14, 15, and 16 extending between the top and bottom faces 11 and 12. The top and bottom faces 11 and 12 and the side faces 13-16 together form a cube. A plurality of heat-dissipating ribs 17 is formed on at least one of the side faces 13-16 in the longitudinal direction. The heat-dissipating ribs 17 extend between and interconnect the top and bottom faces 11 and 12. The heat-dissipating ribs 17 and at least one of the faces 11-16 can be integrally formed as a single and inseparable component of the same material by powder pressing to assure the structural strength. The heat-dissipating ribs 17 increase the heat-dissipating area and the heat-dissipating speed and enhance the heat-dissipating efficiency, obtaining satisfactory performance and stable operation while allowing automatic mass production of the power inductor. In the preferred form shown in FIGS. 1-6, the heat-dissipating ribs 17 are formed on each of two opposite side faces 13 and 14 spaced in a direction perpendicular to the longitudinal direction. In the preferred form shown in FIGS. 7-8, the heat-dissipating ribs 17 are formed on each of the side faces 13-16 to further increase the heat-dissipating area and to further enhance the heat-dissipating efficiency.

In the preferred forms shown in FIGS. 1-8, each of the heat-dissipating ribs 17 of the magnetic enveloping layer 1 is arcuate and protrudes outward. The dissipating ribs 17 are spaced from each other with a heat-dissipating groove 18 formed between two adjacent heat-dissipating ribs 17. The heat-dissipating ribs 17 and the heat-dissipating grooves 18 together form a wavy shape, increasing the heat-dissipating area and enhancing the structural strength. The top face 11 of the magnetic enveloping layer 1 includes a bulged central portion 111 having a spacing to the bottom face in the longitudinal direction larger than a peripheral section surrounding the bulged central portion 111, increasing the heat-dissipating area. Furthermore, the bottom face 12 of the magnetic enveloping layer 1 includes a recessed portion 121.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An inductor comprising a conductive coil and a magnetic enveloping layer surrounding and bonded to the conductive coil, with the magnetic enveloping layer including a top face, a bottom face spaced from the top face in a longitudinal direction, and a plurality of side faces extending between the top and bottom faces, with the conductive coil including two terminals exposed outside of the magnetic enveloping layer, with at least one of the plurality of side faces including a plurality of heat-dissipating ribs.

2. The inductor as claimed in claim 1, with the conductive coil further including a coil portion intermediate the two terminals, with the coil portion having a plurality of turns arranged in a longitudinal direction, with the plurality of side faces including two opposite side faces spaced in a direction perpendicular to the longitudinal direction, with the plurality of heat-dissipating ribs formed on each of the two opposite side faces.

3. The inductor as claimed in claim 1, with the plurality of heat-dissipating ribs formed on each of the plurality of side faces.

4. The inductor as claimed in claim 1, with the top and bottom faces and the plurality of side faces forming a cube, with the plurality of heat-dissipating ribs extending between and interconnecting the top and bottom faces.

5. The inductor as claimed in claim 4, with each of the plurality of heat-dissipating ribs of the magnetic enveloping layer being arcuate and protruding outward, with the plurality of dissipating ribs spaced from each other, with a heat-dissipating groove formed between two of the plurality of heat-dissipating ribs adjacent to each other.

6. The inductor as claimed in claim 5, with the plurality of heat-dissipating ribs and said at least one of the plurality of side faces integrally formed as a single and inseparable component of a same material.

7. The inductor as claimed in claim 6, with the plurality of side faces being planar, with the plurality of heat-dissipating ribs and the heat-dissipating grooves together forming a wavy shape.

8. The inductor as claimed in claim 4, with the conductive coil further including a coil portion intermediate the two terminals, with the coil portion having a plurality of turns arranged in a longitudinal direction, with the top face of the magnetic enveloping layer including a bulged portion, with the bulged portion including a central section and a peripheral section surrounding the central section, with the central section having a spacing to the bottom face in the longitudinal direction larger than the peripheral section.
